(19) United States
(12) Patent Application Publication
(10) Pub. No.: US 2019/0295758 A1
(43) Pub. Date: Sep. 26, 2019

(54) MAGNETIC CORE

(71) Applicant: KABUSHIKI KAISHA KOBE SEIKO SHO (KOBE STEEL, LTD.), Hyogo (JP)

(72) Inventors: Hirotoshi ARIHARA, Hyogo (JP); Komei FUJIOKA, Hyogo (JP); Yuki KAMEYAMA, Hyogo (JP)

(73) Assignee: KABUSHIKI KAISHA KOBE SEIKO SHO (KOBE STEEL, LTD.), Hyogo (JP)

(21) Appl. No.: 16/302,623

(22) PCT Filed: May 16, 2017
(86) PCT No.: PCT/JP2017/018301

§ 371 Date: Nov. 17, 2018

(30) Foreign Application Priority Data
May 20, 2016 (JP) 2016-101504
Oct. 11, 2016 (JP) 2016-200368

(51) Int. Cl. H01F 7/20; H01F 27/28; H01F 27/24

(52) U.S. Cl. CPC H01F 7/20; H01F 27/24; H01F 27/28

(57) ABSTRACT

This magnetic core (1) comprises: a columnar core part (11) that is arranged inside a coil (2); and a tubular yoke part (12) that is arranged outside the coil (2). The core part (11) and the yoke part (12) overlap the arrangement region of the coil (2) in the axial direction. The entirety of the core part (11) is configured from a high magnetic flux density material that has a higher magnetic flux density than commonly used magnetic materials.

### TECHNICAL FIELD

The present invention relates to a magnetic core for use in an electromagnet.

### BACKGROUND ART

A technique such as Patent Literature 1 or 2 has been known for a magnetic core for use in an electromagnet, such as a solenoid core. Patent Literature 1 discloses a magnetic core including a compression-formed body (including magnetic powder (soft magnetic powder) having an insulating film in its surface) as a major part, and a magnetic bulk body (including an Fe—Co alloy) in a front end part thereof. Patent Literature 2 discloses a magnetic core including a magnetic composite material (such as a dust material in which iron-based magnetic powder coated with an insulating material has been molded under pressure) as a major part, and a high magnetic flux density material part which is provided to be held between parts of the magnetic composite material. Patent Literature 1 suggests that due to the aforementioned configuration of the magnetic core, rapid response can be achieved and high-precision surface machining can be performed on a front end surface of the core. Patent Literature 2 suggests that due to the aforementioned configuration of the core, overcurrent can be prevented from occurring easily while keeping the magnetic flux density high.

### CITATION LIST

### Patent Literature

Patent Literature 1: JP-A-2002-235865

Patent Literature 2: JP-A-2005-150308

### SUMMARY OF THE INVENTION

### Technical Problems

On the way of research and development about magnetic cores, the present inventor found that in a configuration shown in Patent Literature 1 or 2, a high magnetic flux density (that is, high magnetic attraction) can be indeed obtained in a high frequency range (not lower than 10 kHz), but a high magnetic flux density (that is, high magnetic attraction) cannot be obtained in a low frequency range (from DC to several hundreds of Hz).

When the size of the magnetic core is increased, the magnetic attraction can be improved. However, due to a problem of an arrangement space or the like, it is desired to improve the magnetic attraction without increasing the size.

An object of the present invention is to provide a magnetic core capable of improving magnetic attraction in a low frequency range without increasing the size of the magnetic core.

### Solution to Problems

The magnetic core according to the present invention includes: a columnar core portion that is disposed inside a cylindrical coil and overlaps with an arrangement region of the coil in an axial direction; and a cylindrical yoke portion that is disposed outside the coil and overlaps with the arrangement region of the coil in the axial direction, and at least the whole of the core portion includes a high magnetic flux density material that has a magnetic flux density higher than that of a general magnetic material.

As described in Examples below, the core portion locally reaches a high magnetic flux density in the low frequency range and tends to be magnetically saturated. According to the present invention, since the whole of the core portion includes the high magnetic flux density material, it is possible to improve the magnetic attraction in the low frequency range without increasing the size of the magnetic core.

The yoke portion may include the general magnetic material. As described in Examples below, the core portion locally reaches a high magnetic flux density in the low frequency range and tends to be magnetically saturated, while the yoke portion does not reach a high magnetic flux density in the low frequency range so that the yoke portion is hardly magnetically saturated. According to the aforementioned configuration, the use amount of the high magnetic flux density material can be reduced as compared with the case where the yoke portion also includes the high magnetic flux density material. Thus, the cost can be reduced. In addition, when the high magnetic flux density material is used for the core portion having high yield and the general magnetic material is used for the yoke portion having low yield, the yield of the high magnetic flux density material can be improved.

The high magnetic flux density material may be an Fe—Co alloy. In this case, among soft magnetic substances, the Fe—Co alloy whose saturated magnetic flux density is high is used as the high magnetic flux density material so that higher magnetic flux density can be obtained in the low frequency range. Thus, it is possible to further improve the magnetic attraction.

The magnetic core according to the present invention may further include: an opposed portion that is connected to the core portion, does not overlap with the arrangement region of the coil in the axial direction, and is opposed to the core portion in the axial direction; and a non-opposed portion that is connected to the opposed portion, does not overlap with the arrangement region of the coil in the axial direction, and is not opposed to the core portion in the axial direction, and a corner portion formed by the core portion and the non-opposed portion may have a round shape or a chamfered shape. As described in Examples below, when the corner portion formed by the core portion and the non-opposed portion has a. right angle shape, magnetic flux concentrates on the corner portion to increase the magnetic flux density locally in the corner portion. Thus, the corner portion tends to be magnetically saturated. According to the aforementioned configuration, since the corner portion formed by the core portion and the non-opposed portion has a round shape or a chamfered shape, the concentration of the magnetic flux on the corner portion can be avoided to further improve the magnetic attraction in the low frequency range.

The magnetic core according to the present invention may further include an opposed portion that is connected to the core portion, does not overlap with the arrangement region of the coil in the axial direction, and is opposed to the core portion in the axial direction, and the opposed portion may include the high magnetic flux density material. As described in Examples below, the magnetic flux density of the opposed portion increases locally in the low frequency range so that the opposed portion tends to be magnetically saturated. According to the aforementioned configuration, not only the core portion but also the opposed portion include the high magnetic flux density material, thereby obtaining higher magnetic flux density in the low frequency range. Thus, it is possible to further improve the magnetic attraction.

The magnetic core according to the present invention may include a columnar core member that includes the core portion and the opposed portion. In this case, when the core member having a simple shape includes the high magnetic flux density material, the magnetic core can be manufactured easily. In addition, the use amount of the high magnetic flux density material can be reduced as compared with the case where the non-opposed portion also includes the high magnetic flux density material. Thus, the cost can be reduced.

The magnetic core according to the present invention may further include a non-opposed portion that is connected to the opposed portion, does not overlap with the arrangement region of the coil in the axial direction, and is not opposed to the core portion in the axial direction, and at least an inner part connected to the opposed portion in the non-opposed portion may include the high magnetic flux density material. As described in Examples below, the magnetic flux density of the inner part of the non-opposed portion increases locally in the low frequency range so that the inner part tends to be magnetically saturated. According to the aforementioned configuration, since not only the core portion but also the opposed portion and at least the inner part of the non-opposed portion include the high magnetic flux density material, higher magnetic flux density can be obtained in the low frequency range. Thus, it is possible to further improve the magnetic attraction.

The non-opposed portion may include an inner part that is connected to the opposed portion and an outer part that is disposed on the outer side of the coil relative to the inner part, and the inner part may include the high magnetic flux density material, and the outer part may include the general magnetic material. In this case, the use amount of the high magnetic flux density material can be reduced as compared with the case where both the inner part and outer part of the non-opposed portion include the high magnetic flux density material. Thus, the cost can be reduced.

A weld portion does not have to be provided in a surface where a through-hole through which a wire of the coil can pass is opened. In this case, molten metal can be prevented from flowing into the through-hole during welding. Thus, it is possible to prevent a problem that coating of the wire or a body of the wire is damaged by the molten metal or a problem that the through-hole is clogged with the molten metal.

The through-hole through which a wire of the coil can pass may be provided in a yoke member forming the yoke portion and may not be provided in a core member forming the core portion. In this case, the wire can be inserted without influence of positioning accuracy of the core member.

The yoke member forming the yoke portion may include a fitting portion that is fitted to the core member forming the core portion, in this case, it is possible to prevent a variation in assembling position between the yoke member and the core member or axial displacement and radial displacement caused by thermal deformation. Hence the core portion can be prevented from being displaced radially from a predetermined position or inclined with respect to the axial direction, so that an arrangement space for the coil can be ensured surely. It is therefore possible to prevent failure in assembling. In addition, when the core portion is inclined with respect to the axial direction, the radial distance between the core portion and the yoke portion becomes uneven in the axial direction to lower the magnetic attraction. However, this problem can be avoided by the aforementioned configuration. Further, the gap between the yoke member and the core member is eliminated so that magnetic flux can pass therethrough easily. Thus, it is possible to further improve the magnetic attraction.

The yoke member forming the yoke portion may include a locking portion that is disposed in at least a part of the core member and outside the core member in the axial direction so that the core member forming the core portion is locked to the lock portion. For example, under the environment where pressure is low on the outer side in the axial direction and high on the opposite side thereto, when the locking portion is not provided, but the yoke member and the core member are fixed to each other only by welding, there may arise a problem that a force with which the core member tries to move to the outside in the axial direction acts on the weld portion so that the weld portion is broken to allow the core member to escape to the outside in the axial direction. However, according to the aforementioned configuration, such a force can be received by the locking portion. Thus, it is possible to effectively prevent the problem that the core member can escape to the outside in the axial direction.

At least a part of the core member may include a first slope that is inclined with respect to the axial direction, and the locking portion may include a second slope that is inclined with respect to the axial direction so as to contact with the first slope. In this case, due to locking by the contact between the slopes, the locking portion can be prevented from protruding from the core member in the axial direction. Thus, it is possible to avoid the increase in the size of the magnetic core in the axial direction.

The core portion may be a solid body. In this case, higher magnetic flux density can be obtained as compared with the case where the core portion is not a solid body (that is, the core portion has a hollow). Thus, it is possible to further improve the magnetic attraction.

### Advantageous Effects of the Invention

According to the present invention, the whole of a core portion include a high magnetic flux density material so that magnetic attraction in a low frequency range can be improved without increasing the size of a magnetic core.

### BRIEF DESCRIPTION OF THE DRAWINGS

FIG. 1 is a sectional view of an electromagnet using a magnetic core according to a first embodiment of the present invention, taken along an axial direction.

FIG. 2 is a plan view of the magnetic core according to the first embodiment of the present invention.

FIG. 3 is a sectional view of an electromagnet using a magnetic core according to a second embodiment of the present invention, taken along an axial direction.

FIG. 4 is a sectional view of an electromagnet using a magnetic core according to a third embodiment of the present invention, taken along an axial direction.

FIG. 5 is a sectional view of an electromagnet using a magnetic core according to a fourth embodiment of the present invention, taken along an axial direction,

FIG. 6 is a sectional view of an electromagnet using a magnetic core according to a fifth embodiment of the present invention, taken along an axial direction.

FIG. 7 is a sectional view of an electromagnet using a magnetic core according to a sixth embodiment of the present invention, taken along an axial direction.

FIG. 8 is a sectional view of an electromagnet using a magnetic core according to a seventh embodiment of the present invention, taken along an axial direction.

FIG. 9 is a sectional view of an electromagnet using a magnetic core according to an eighth embodiment of the present invention, taken along an axial direction.

FIG. 10 is a plan view of the magnetic core according to the eighth embodiment of the present invention.

FIG. 11 is a sectional view of an electromagnet using a magnetic core according to a ninth embodiment of the present invention, taken along an axial direction.

FIG. 12 is a sectional view of an electromagnet using a magnetic core according to a tenth embodiment of the present invention, taken along an axial direction.

FIG. 13 is a sectional view of an electromagnet using a magnetic core according to an eleventh embodiment of the present invention, taken along an axial direction.

FIG. 14 is a sectional view of an electromagnet using a magnetic core according to a twelfth embodiment of the present invention, taken along an axial direction.

FIG. 15 is a sectional view of an electromagnet using a magnetic core according to a thirteenth embodiment of the present invention, taken along an axial direction.

FIG. 16 is a schematic diagram showing an analytic result of a magnetic flux density distribution in a case where a current is applied to a coil in an electromagnet using a magnetic core according to Comparative Example in the present invention.

FIG. 17 is a schematic diagram showing an analytic result of a magnetic flux density distribution in a case where a current is applied to a coil in an electromagnet using a magnetic core according to Examples of the present invention.

FIG. 18 is a graph showing magnetic attractions in a low frequency range, including magnetic attractions of the magnetic core according to Example of the present invention and magnetic cores according to Comparative Examples 1 and 2.

### DESCRIPTION OF EMBODIMENTS

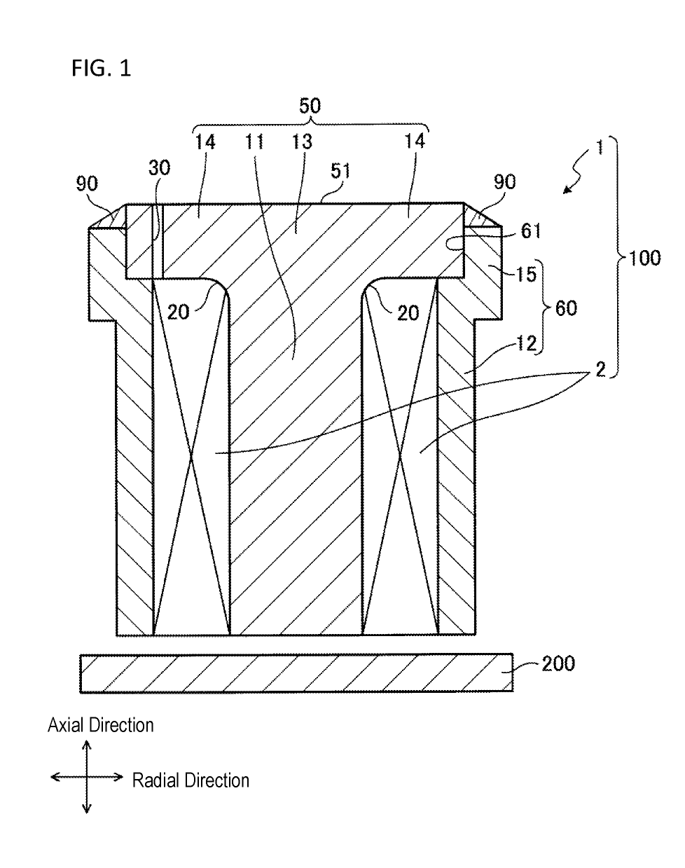

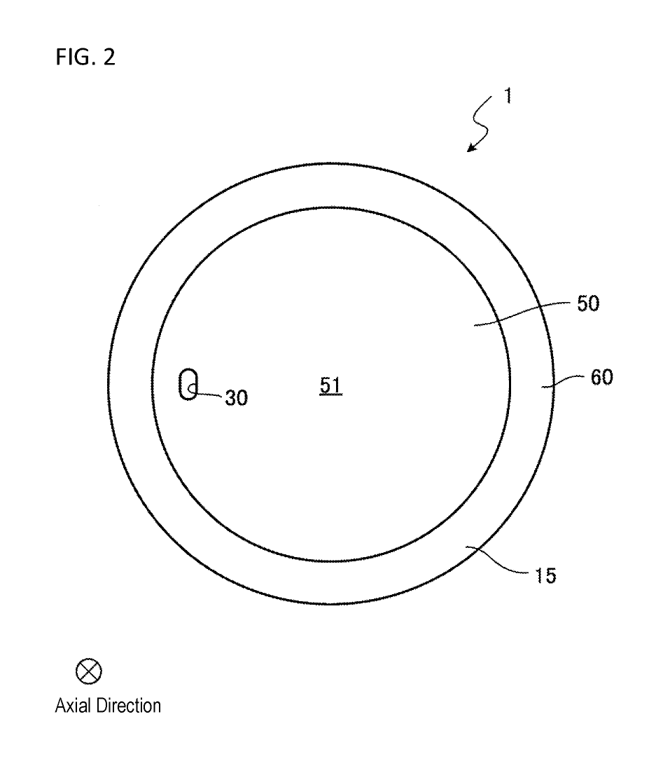

First, an electromagnet 100 using a magnetic core 1 according to a first embodiment of the present invention is described with reference to FIG. 1 and FIG. 2.

The electromagnet 100 includes the magnetic core 1 and a coil 2.

The coil 2 is formed into a cylindrical shape by winding a wire a plurality of times.

The magnetic core 1 includes a core member 50 and a yoke member 60.

The core member 50 includes a core portion 11 that is a columnar solid body disposed inside the coil 2, a columnar opposed portion 13 that is connected to one end of the core portion 11 in an axial direction thereof (hereinafter, the axial direction of the core portion 11 is referred to as “axial direction” simply) and is opposed to the core portion 11 in the axial direction, and a cylindrical non-opposed portion 14 that is connected to an outer edge of the opposed portion 13 (that is, an end portion of the opposed portion 13 in a radial direction of the core portion 11 (hereinafter, the radial direction of the core portion 11 is referred to as “radial direction” simply)) and is not opposed to the core portion 11 in the axial direction. A through-hole 30 through which a wire of the coil 2 can pass is provided along the axial direction in the non-opposed portion 14. The wire of the coil 2 is extracted to the outside of the magnetic core 1 through the through-hole 30.

The yoke member 60 includes a cylindrical yoke portion 12 that is disposed outside the coil 2, and an extension portion 15 that is connected to one end of the yoke portion in the axial direction and extends from the one end in the axial direction.

The core portion 11 and the yoke portion 12 overlap with the arrangement region of the coil 2 in the axial direction. The opposed portion 13, the non-opposed portion 14 and the extension portion 15 do not overlap with the arrangement region of the coil 2 in the axial direction.

A corner portion 20 formed by the core portion 11 and the non-opposed portion 14 has a round shape along the whole of the axis of the core portion 11. In addition, an annular concave portion 61 for fitting to the outer edge of the non-opposed portion 14 of the core member 50 is provided in the yoke member 60.

At least the core member 50 includes a high magnetic flux density material that has a magnetic flux density higher than that of a general magnetic material. The yoke member 60 includes the general magnetic material. Here, the general magnetic material is a material whose saturated magnetic flux density is 2.0 T (tesla) or less. For example, the general magnetic material is a rolled steel for a general structure (such as SS400) or silicon steel. The high magnetic flux density material is a material whose saturated magnetic flux density exceeds 10 T (tesla). Examples of such high magnetic flux density materials include Fe—Co alloys, pure iron, iron nitride, magnetic steel materials containing bismuth, and the like. Among the Fe—Co alloys, materials containing aluminum oxide, Fe-49Co-2V, and Fec5Co35 are suitable as the high magnetic density materials due to their high saturated magnetic flux density.

The magnetic core 1 is obtained as follows. That is, the core member 50 and the yoke member 60 are produced individually. The core member 50 and the yoke member 60 are then assembled integrally by press fitting or welding (specifically, the outer edge of the non-opposed portion 14 of the core member 50 is fitted to the concave portion 61 of the yoke member 60, and an annular weld portion 90 is provided in a corner portion formed between the outer circumferential surface of the non-opposed portion 14 and one axial end surface of the extension portion 15, so that the core member 50 and the yoke member 60 are integrated). The weld portion 90 is not provided in a surface 51 (where the through-hole 30 is opened) opposite to the core portion 11 in the axial direction, of a surface of a part forming the opposed portion 13 and the non-opposed portion 14 in the core member 50.

It is preferable that the magnetic core 1 is processed to have a uniform distance in the axial direction between an end surface opposed to a counterpart material 200 on which the magnetic attraction should act (that is, the other end surface of the core portion in the axial direction and the other end surface of the yoke portion 12 in the axial direction) and a surface of the counterpart material 200 opposed to the magnetic core 1. For example, when the surface of the counterpart material 200 is flat, the end surface of the magnetic core 1 is also made flat. When the surface of the counterpart material 200 has a curved shape or a concave-convex shape, the end surface of the magnetic core 1 is also formed into a curved shape or a concave-convex shape following the surface of the counterpart material 200.

The electromagnet 100 including the magnetic core 1 can acquire high magnetic attraction particularly in a low frequency range (from DC to several hundreds of Hz). For example, the electromagnet 100 can be used as a magnetic force generator in an apparatus for measuring dynamic characteristics of a centrifugal type rotary machine, disclosed in JP-A-2014-102117 which is an earlier application filed by the inventor of the present application. When the electromagnet 100 is used as the magnetic force generator in the apparatus for measuring the dynamic characteristics, the dynamic characteristics of a rotor can be measured with high accuracy.

According to the present embodiment, as described above, the whole of the core portion 11 includes a high magnetic flux density material. As described. in Examples below, the core portion 11 locally reaches high magnetic flux density in the low frequency range and tends to be magnetically saturated. According to the present embodiment, since the whole of the core portion 11 includes the high magnetic flux density material, it is possible to improve the magnetic attraction in the low frequency range without increasing the size of the magnetic core 1.

The yoke portion 12 includes the general magnetic material. As described in Examples below, the core portion 11 locally reaches high magnetic flux density in the low frequency range and tends to he magnetically saturated, while the yoke portion 12 does not reach high magnetic flux density in the low frequency range so that the yoke portion 12 is hardly magnetically saturated. According to the aforementioned configuration, the use amount of the high magnetic flux density material can be reduced as compared with the case where the yoke portion 12 also includes the high magnetic flux density material. Thus, the cost can be reduced. In addition, when the high magnetic flux density material is used for the core portion 11 having high yield and the general magnetic material is used for the yoke portion 12 having low yield, the yield of the high magnetic flux density material can be improved.

The high magnetic flux density material may be an Fe—Co alloy. In this case, among soft magnetic substances, the Fe—Co alloy whose saturated magnetic flux density is high is used as the high magnetic flux density material so that higher magnetic flux density can be obtained in the low frequency range. Thus, it is possible to further improve the magnetic attraction.

The corner portion 20 formed by the core portion 11 and the non-opposed portion 14 has a round shape. As described in Examples below, when the corner portion 20 has a right angle shape, magnetic flux concentrates on the corner portion 20 to increase the magnetic flux density locally in the corner portion 20. Thus, the corner portion 20 tends to he magnetically saturated. According to the aforementioned configuration, since the corner portion 20 has a round shape, the concentration of the magnetic flux on the corner portion 20 can be avoided to further improve the magnetic attraction in the low frequency range. The effect obtained by the shape of the corner portion 20 formed thus can be obtained independently of the material forming the corner portion 20 (that is, in both of the case where the corner portion 20 includes the high magnetic flux density material and the case where the corner portion 20 includes the general magnetic material).

The opposed portion 13 includes the high magnetic flux density material. As described in Examples below, the magnetic flux density of the opposed portion 13 increases locally in the low frequency range so that the opposed portion 13 tends to he magnetically saturated. According to the aforementioned configuration, since not only the core portion 11 but also the opposed portion 13 include the high magnetic flux density material, higher magnetic flux density can be obtained in the low frequency range. Thus, it is possible to further improve the magnetic attraction.

Of the non-opposed portion 14, at least an inner part that is connected to the opposed portion 13 (in the present embodiment, the whole of the non-opposed portion 14) includes the high magnetic flux density material. As described in Examples below, the magnetic flux density of the inner part of the non-opposed portion 14 increases locally in the low frequency range so that the inner part tends to be magnetically saturated.

According to the aforementioned configuration, since not only the core portion 11 but also the opposed portion 13 and at least the inner part of the non-opposed portion 14 include the high magnetic flux density material, higher magnetic flux density can be obtained in the low frequency range. Thus, it is possible to further improve the magnetic attraction.

The weld portion 90 is not provided in a surface 51 where the through-hole 30 through which a wire of the coil 2 can pass is opened. In this case, molten metal can be prevented front flowing into the through-hole 30 during welding. Thus, it is possible to prevent a problem that coating of the wire or a body of the wire is damaged by the molten metal or a problem that the through-hole 30 is clogged with the molten metal.

The yoke member 60 includes a concave portion 61 for fitting to the core member 50. In this case, it is possible to prevent a variation in assembling position between the yoke member 60 and the core member 50 or axial displacement and radial displacement caused by thermal deformation. Hence the core portion 11 can be prevented from being displaced radially from a predetermined position or inclined with respect to the axial direction, so that an arrangement space for the oil 2 can be ensured surely. It is therefore possible to prevent failure in assembling. In addition, when the core portion 11 is inclined with respect to the axial direction, the radial distance between the core portion 11 and the yoke portion 12 becomes uneven in the axial direction to lower the magnetic attraction. However, this problem can be avoided by the aforementioned configuration. Further, the gap between the yoke member 60 and the core member 50 is eliminated so that magnetic flux can pass therethrough easily. Thus, it is possible to further improve the magnetic attraction.

The core portion 11 is a solid body. In this case, higher magnetic flux density can be obtained as compared with the case where the core portion 11 is not a solid body (that is, has a hollow). Thus, it is possible to further improve the magnetic attraction.

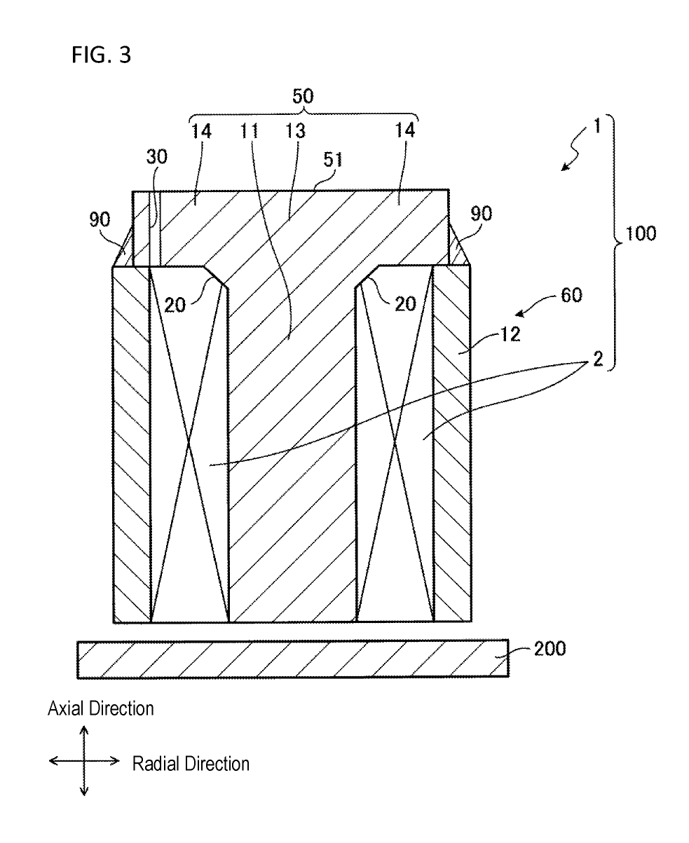

Next, a second embodiment of the present invention is described with reference to FIG. 3.

A magnetic core 1 according to the second embodiment has the same configuration as the magnetic core 1 according to the first embodiment, except that the corner portion 20 has not a round shape but a. chamfered shape, that the yoke member 60 includes only the yoke portion 12 but does not include the extension portion 15, that the yoke member 60 is not provided with the concave portion 61, and that the weld portion 90 is provided not in a corner portion formed between the outer circumferential surface of the non-opposed portion 14 and one end surface of the extension portion 15 in the axial direction but in a corner portion formed between the outer circumferential surface of the non-opposed portion 14 and one end surface of the yoke portion 12 in the axial direction.

According to the second embodiment, similar effects to those of the first embodiment can be obtained by the similar configuration to that of the first embodiment, and the following effect can be obtained in addition thereto.

In the second embodiment, the corner portion 20 formed by the core portion 11 and the non-opposed portion 14 has a chamfered shape. As described in Examples below, when the corner portion 20 has a right angle shape, magnetic flux concentrates on the corner portion 20 to increase the magnetic flux density locally in the corner portion 20. Thus, the corner portion 20 tends to be magnetically saturated. According to the aforementioned configuration, since the corner portion 20 has a chamfered shape, the concentration of the magnetic flux on the corner portion 20 can be prevented to further improve the magnetic attraction in the low frequency range. The effect obtained by the shape of the corner portion 20 formed thus can be obtained independently of the material forming the corner portion 20 (that is, in both of the case where the corner portion 20 includes the high magnetic flux density material and the case where the corner portion 20 includes the general magnetic material).

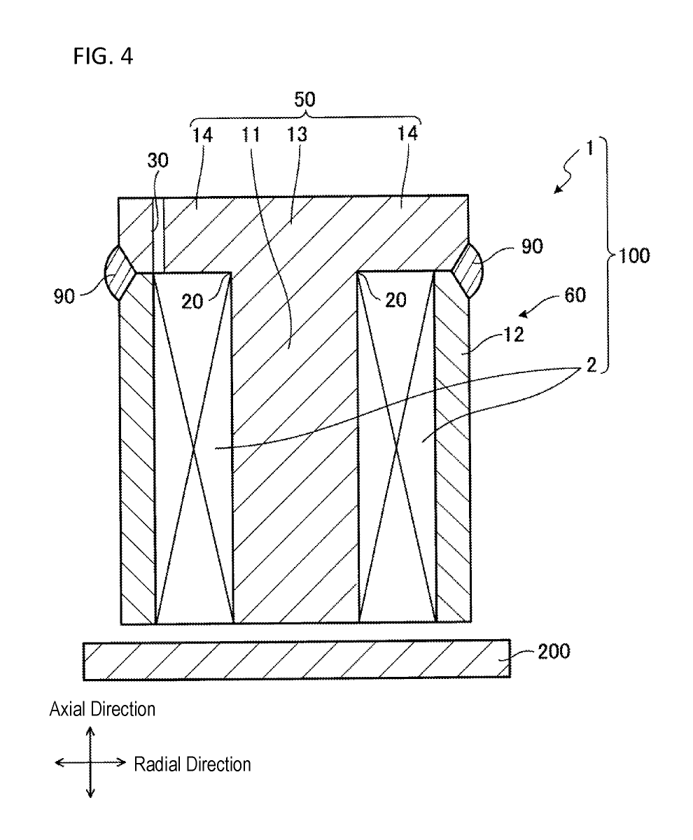

Next, a third embodiment of the present invention is described with reference to FIG. 4.

A magnetic core 1 according to the third embodiment has the same configuration as the magnetic core 1 according to the second embodiment, except that the corner portion 20 has a right angle shape, that the outer diameter of a part forming the opposed portion 13 and the non-opposed portion 14 in the core member 50 is as large as the outer diameter of the yoke member 60 (that is, the outer circumferential surface of the non-opposed portion 14 and the outer circumferential surface of the yoke portion 12 overlap with each other in the radial direction), and that the weld portion 90 is provided not in the corner portion formed between the outer circumferential surface of the non-opposed portion 14 and one end surface of the yoke portion 12 in the axial direction but in a boundary portion between the outer circumferential surface of the non-opposed portion 14 and the outer circumferential surface of the yoke portion 12.

According to the third embodiment, similar effects to those of the second embodiment can be obtained by the similar configuration to that of the second embodiment.

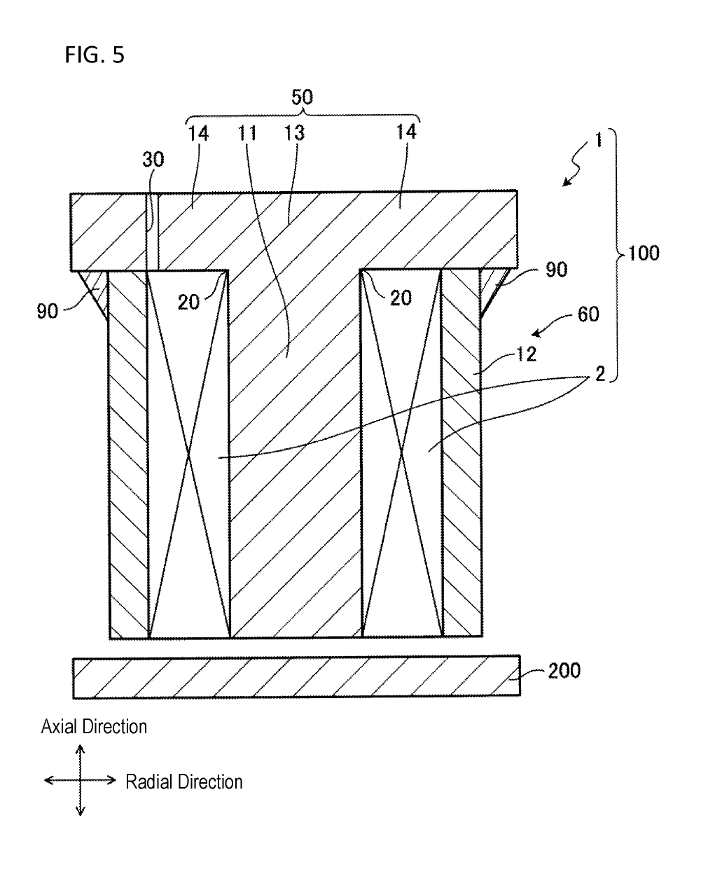

Next, a fourth embodiment of the present invention is described with reference to FIG. 5.

A magnetic core 1 according to the fourth embodiment has the same configuration as the magnetic core 1 according to the third embodiment, except that the outer diameter of the part forming the opposed portion 13 and the non-opposed portion 14 in the core member 50 is larger than the outer diameter of the yoke member 60 (that is, the outer circumferential surface of the non-opposed portion 14 is located outside the outer circumferential surface of the yoke portion 12 in the radial direction), and that the weld portion 90 is provided not in the boundary portion between the outer circumferential surface of the non-opposed portion 14 and the outer circumferential surface of the yoke portion 12 but in a corner portion formed between the other end surface of the non-opposed portion 14 in the axial direction and the outer circumferential surface of the yoke portion 12.

According to the fourth embodiment, similar effects to those of the third embodiment can be obtained by the similar configuration to that of the third embodiment,

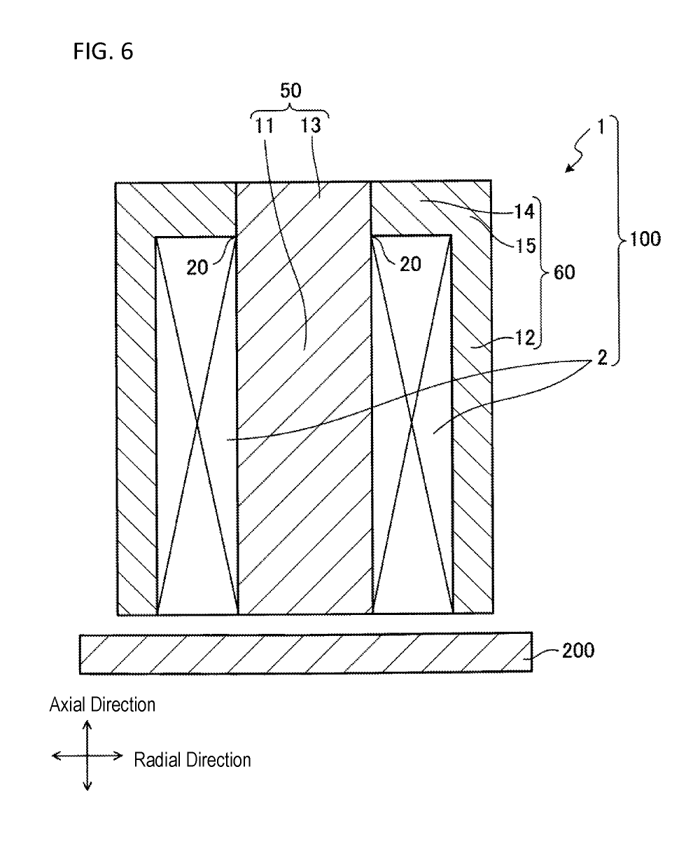

Next, a fifth embodiment of the present invention is described with reference to FIG. 6.

A magnetic core 1 according to the fifth embodiment has the same configuration as the magnetic core 1 according to the third embodiment, except that the core member 50 is a columnar member including the core portion 11 and the opposed portion 13 but not including the non-opposed portion 14, and that the yoke member 60 includes not only the yoke portion 12 but also the extension portion 15 and the non-opposed portion 14. Although the weld portion 90 and the through-hole 30 are not shown in FIG. 6, the core member 50 and the yoke member 60 may be, for example, assembled integrally by a method (such as press fitting) other than ⁻welding, and the through-hole 30 does not have to be provided. In the fifth embodiment, the columnar core member 50 including the core portion 11 and the opposed portion 13 includes the high magnetic flux density material, and the bottomed cylindrical yoke member 60 (where a hole into which the opposed portion 13 of the core member 50 can be fitted is formed in a bottom portion of the yoke member 60) including the yoke portion 12 and the non-opposed portion 14 includes the general magnetic material.

According to the fifth embodiment, similar effects to those of the third embodiment can be obtained by the similar configuration to that of the third embodiment,

The magnetic core 1 according to the fifth embodiment includes the core member 50 which is a columnar member including the core portion 11 and the opposed portion 13. In this case, when the core member 50 having a simple shape (columnar shape) includes the high magnetic flux density material, the magnetic core 1 can be manufactured easily. In addition, the use amount of the high magnetic flux density material can be reduced as compared with the case where the non-opposed portion 14 also include the high magnetic flux density material. Thus, the cost can be reduced.

Next, a sixth embodiment of the present invention is described with reference to FIG, 7.

A magnetic core 1 according to the sixth embodiment has the same configuration as the magnetic core 1 according to the fifth embodiment, except that the core member 50 is not a columnar member including the core portion 11 and the opposed portion 13 but includes the core portion 11, the opposed portion 13 and a part of the non-opposed portion 14 (an inner part 14a of the non-opposed portion 14 connected to the opposed portion 13), and that the yoke member 60 does not include the yoke portion 12 and the whole of the non-opposed portion 14 but includes the yoke portion 12 and a part of the non-opposed portion 14 (an outer part 14b of the non-opposed portion 14 disposed on the outer side of the coil 2 relative to the inner part 14a). In the sixth embodiment, the non-opposed portion 14 is divided into the inner part 14a included in the core member 50 and the outer part 14b included in the yoke member 60, and the inner part 14a includes the high magnetic flux density material while the outer part 14b includes the general magnetic material.

According to the sixth embodiment, similar effects to those of the fifth embodiment can be obtained by the similar configuration to that of the fifth embodiment, and the following effect can be obtained in addition thereto.

In the sixth embodiment, the non-opposed portion 14 includes the inner part 14a connected to the opposed portion 13, and the outer part 14b disposed on the outer side of the coil 2 relative to the inner part 14a, and the inner part 14a includes the high magnetic flux density material while the outer part 14b includes the general magnetic material. In this case, the use amount of the high magnetic flux density material can be reduced as compared with the case where both the inner part 14a and the outer part 14b in the non-opposed portion 14 include the high magnetic flux density material. Thus, the cost can be reduced.

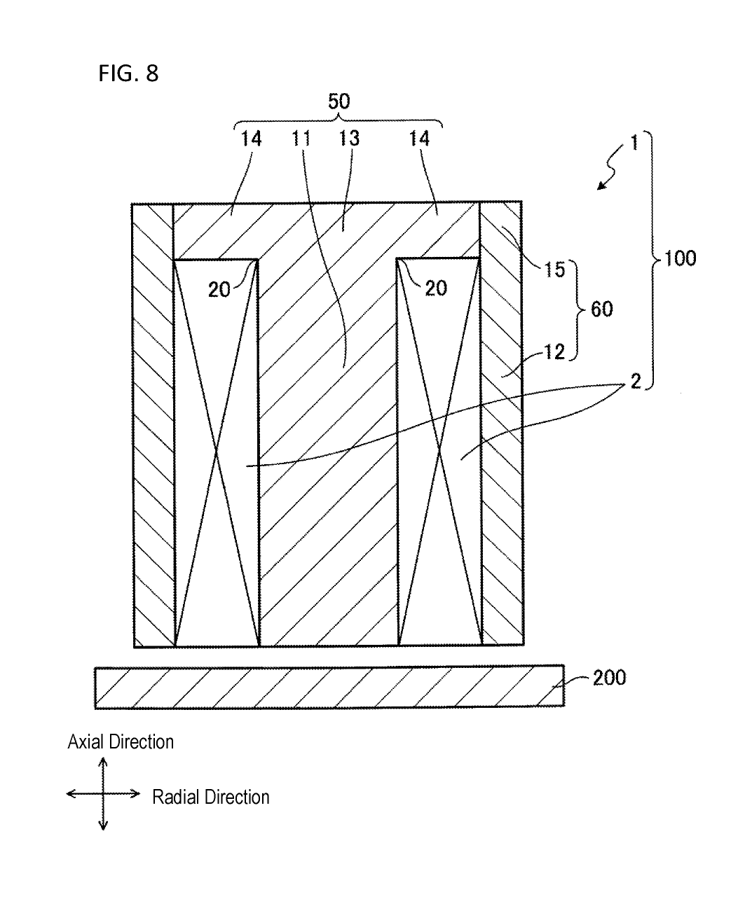

Next, a seventh embodiment of the present invention is described with reference to FIG. 8.

A magnetic core 1 according to the seventh embodiment has the same configuration as the magnetic core 1 according to the fifth embodiment, except that the core member 50 is not a columnar member including the core portion 11 and the opposed portion 13 but includes the core portion 11, the opposed portion 13 and the non-opposed portion 14, and that the yoke member 60 does not include the yoke portion 12 and the non-opposed portion 14 but includes the yoke portion 12 and the extension portion 15.

According to the seventh embodiment, similar effects to those of the fifth embodiment can be obtained by the similar configuration to that of the fifth embodiment.

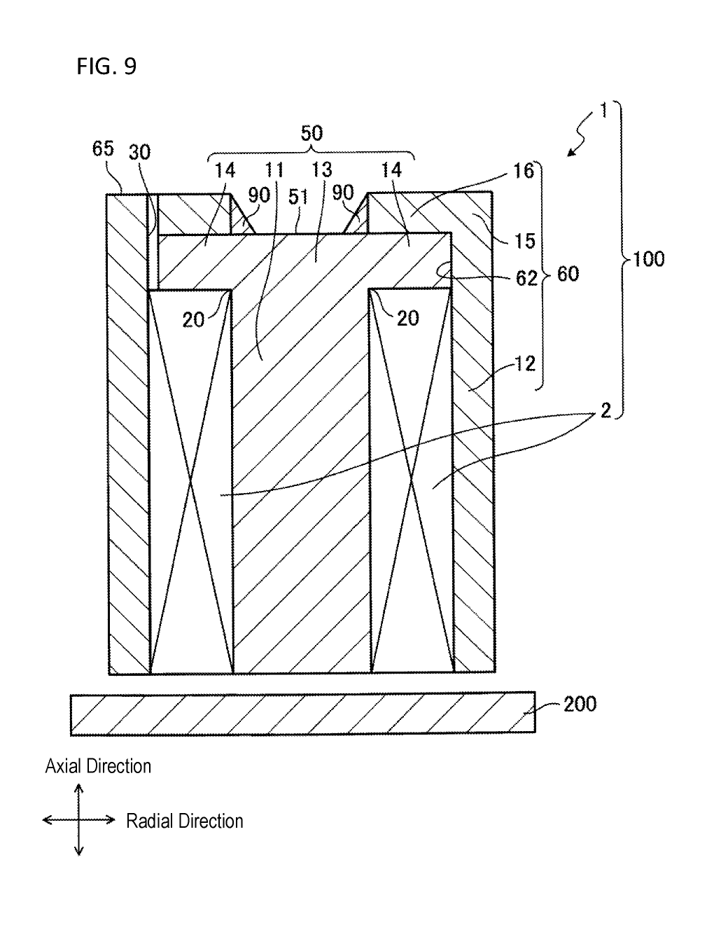

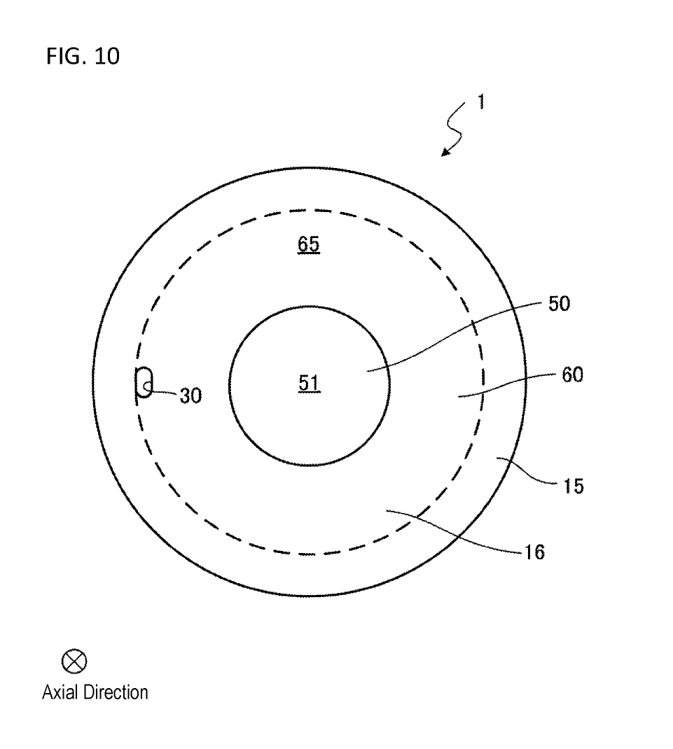

Next, an eighth embodiment of the present invention is described with reference to FIG. 9 and FIG. 10.

A magnetic core 1 according to the eighth embodiment has the same configuration as the magnetic core 1 according to the seventh embodiment, except that the extension portion 15 further extends in the axial direction to provide an annular locking portion 16 protruding inward in the radial direction from the front end of the extension portion 15, that the outer edge of the non-opposed portion 14 of the core member 50 is fitted into a concave portion 62 (a concave portion formed by a cylindrical portion including the yoke portion 12 and the extension portion 15, and the locking portion 16) of the yoke member 60, and that the through-hole 30 is provided along the axial direction in the locking portion 16 of the yoke member 60 and the non-opposed portion 14 of the core member 50. In the eighth embodiment, the annular weld portion 90 is provided in a. corner portion formed between the surface 51 of the core member 50 and an inner circumferential side end surface of the locking portion 16 of the yoke member 60. The weld portion 90 is not provided in a surface 65 (a surface on the opposite side to the yoke portion 12 in the axial direction (a surface where the through-hole 30 is opened)) of the yoke member 60.

According to the eighth embodiment, similar effects to those of the seventh embodiment can be obtained by the similar configuration to that of the seventh embodiment, and the following effects can be obtained in addition thereto.

In the eighth embodiment, the weld portion 90 is not provided in the surface 65 where the through-hole 30 through which the wire of the coil 2 can pass is opened. In this case, molten metal can be prevented from flowing into the through-hole 30 during welding. Thus, it is possible to prevent a problem that coating of the wire or a body of the wire is damaged by the molten metal or a problem that the through-hole 30 is clogged with the molten metal.

In addition, in the eighth embodiment, the yoke member 60 includes the concave portion 62 for fitting to the core member 50. In this case, it is possible to prevent a variation in assembling position between the yoke member 60 and the core member 50 or axial displacement and radial displacement caused by thermal deformation. Hence the core portion 11 can be prevented from being displaced radially from a predetermined position or inclined with respect to the axial direction, so that an arrangement space for the coil 2 can be ensured surely. It is therefore possible to prevent failure in assembling. In addition, when the core portion 11 is inclined with respect to the axial direction, the radial distance between the core portion 11 and the yoke portion 12 becomes uneven in the axial direction to lower the magnetic attraction. However, this problem can be avoided by the aforementioned configuration. Further, the gap between the yoke member 60 and the core member 50 is eliminated so that magnetic flux can pass therethrough easily. Thus, it is possible to further improve the magnetic attraction.

In addition, in the eighth embodiment, the yoke member 60 includes the locking portion 16 for locking the core member 50. The locking portion 16 is disposed on the outer side in the axial direction (upper side in FIG. 9) of at least a part (non-opposed portion 14) of the core member 50. For example, under the environment where pressure is low (such as atmospheric) on the outer side (a space where the magnetic core 1 is disposed) in the axial direction with respect to the counterpart material 200 and pressure is high on the opposite side thereto (a space where the counterpart material 200 is disposed), when the locking portion 16 is not provided, but the yoke member 60 and the core member 50 are fixed to each other only by welding, there may arise a problem that a force with which the core member 50 tries to move to the outside (upper side in FIG. 9) in the axial direction acts on the weld portion 90 so that the weld portion 90 is broken to allow the core member 50 to escape to the outside in the axial direction. However, according to the aforementioned configuration, such a force can be received by the locking portion 16. Thus, it is possible to effectively prevent the problem that the core member 50 can escape to the outside in the axial direction.

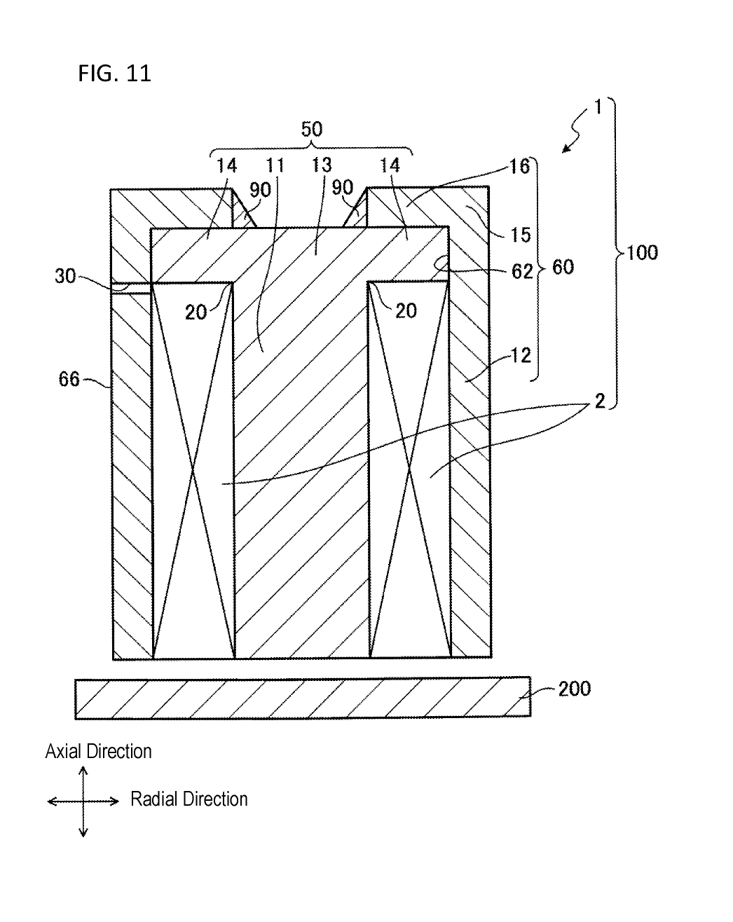

Next, a ninth embodiment of the present invention is described with reference to FIG. 11.

A magnetic core 1 according to the ninth embodiment has the same configuration as the magnetic core 1 according to the eighth embodiment, except that the through-hole 30 is provided along the radial direction in the yoke portion 12. The weld portion 90 is not provided in a surface 66 (a surface where the through-hole 30 is opened)) of the yoke portion 12 in the yoke member 60.

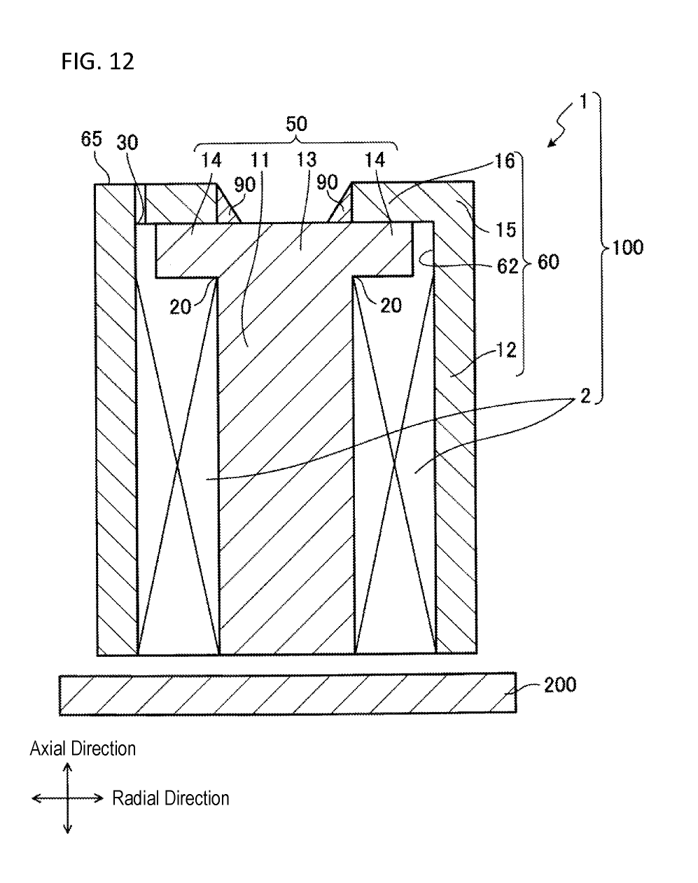

Next, a tenth embodiment of the present invention is described with reference to FIG. 12.

A magnetic core 1 according to the tenth embodiment has the same configuration as the magnetic core 1 according to the eighth embodiment, except that the length of the non-opposed portion 14 in the radial direction is so short that the outer edge of the non-opposed portion 14 is not fitted into the concave portion 62 of the yoke member 60, and that the through-hole 30 is not provided in the non-opposed portion 14 but is provided along the axial direction in the locking portion 16.

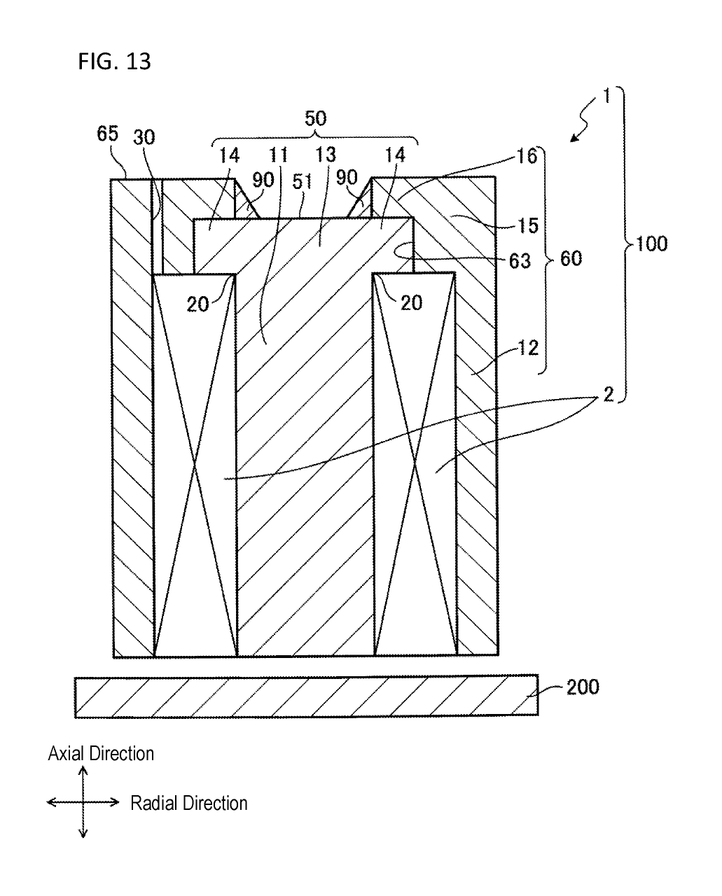

Next, an eleventh embodiment of the present invention is described with reference to FIG. 13.

A magnetic core 1 according to the eleventh embodiment has the same configuration as the magnetic core 1 according to the eighth embodiment, except that the extension portion 15 of the yoke member 60 protrudes inward in the radial direction so that the outer edge of the non-opposed portion 14 having a short length in the radial direction is fitted into a concave portion 63 (an annular concave portion formed by the extension portion 15 and the locking portion 16) of the yoke member 60, and that the through-hole 30 is not provided in the non-opposed portion 14 but is provided along the axial direction in a part of the extension portion 15 protruding inward in the radial direction relative to the yoke portion 12.

According to the ninth to eleventh embodiments, similar effects to those of the eighth embodiment can be obtained by the similar configurations to that of the eighth embodiment, and the following effect can be obtained in addition thereto.

In the ninth to eleventh embodiments, the through-hole 30 through which the wire of the coil 2 can pass is provided not in the core member 50 but in the yoke member 60. In this case, the wire can be inserted with no influence of the positioning accuracy of the core member 50.

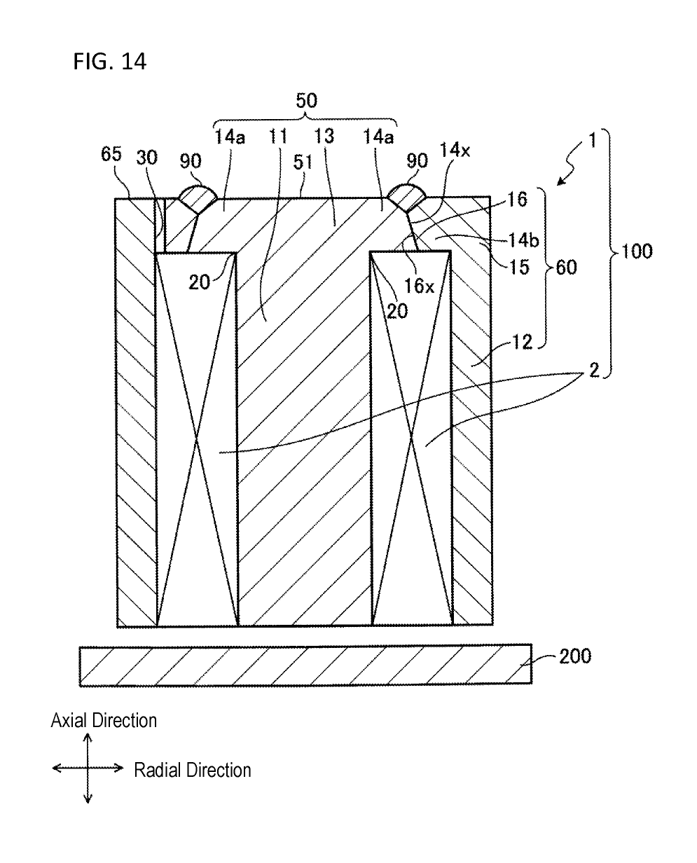

Next, a twelfth embodiment of the present invention is described with reference to FIG. 14.

A magnetic core 1 according to the twelfth embodiment has the same configuration as the magnetic core 1 according to the sixth embodiment, except that the inner part 14a and the outer part 14b are in contact with each other not in surfaces extending along the axial direction but in slopes 14x and 16x inclined with respect to the axial direction, and that the through-hole 30 is provided along the axial direction in the outer part 14b of the yoke member 60. In the twelfth embodiment, the inner front end of the outer part 14b in the radial direction serves as the locking portion 16 for locking the core member 50. The locking portion 16 is disposed on the outer side (upper side in FIG. 14) of at least a part (the outer front end of the inner part 14a in the radial direction) of the core member 50. The locking portion 16 includes the slope 16x which is in contact with the slope 14x provided in the outer front end of the inner part 14a in the radial direction.

Each of slope 14x and slope 16x is inclined inward in the radial direction as goes outward (toward the upper in FIG. 14) in the radial direction. The slope 16x also serves as a fitting portion for fitting to the core member 50. In addition, in the twelfth embodiment, the weld portion 90 having an annular shape is provided between the surface 51 of the core member 50 and the surface 65 of the yoke member 60 (that is, between the inner part 14a and the outer part 14b).

According to the twelfth embodiment, similar effects to those of the sixth embodiment can be obtained by the similar configuration to that of the sixth embodiment, and the following effect can be obtained in addition thereto.

In the twelfth embodiment, the through-hole 30 through which the wire of the coil 2 can pass is provided not in the core member 50 but in the yoke member 60. In this case, the wire can be inserted with no influence of the positioning accuracy of the core member 50.

In addition, in the twelfth embodiment, the yoke member 60 includes the fitting portion (slope 16x) for fitting to the core member 50. In this case, it is possible to prevent a variation in assembling position between the yoke member 60 and the core member 50 or axial displacement and radial displacement caused by thermal deformation. Hence the core portion 11 can be prevented from being displaced radially from a predetermined position or inclined with respect to the axial direction, so that an arrangement space for the coil 2 can be ensured surely. It is therefore possible to prevent failure in assembling. In addition, when the core portion 11 is inclined with respect to the axial direction, the radial distance between the core portion 11 and the yoke portion 12 becomes uneven in the axial direction to lower the magnetic attraction. However, this problem can be avoided by the aforementioned configuration. Further, the gap between the yoke member 60 and the core member 50 is eliminated so that magnetic flux can pass therethrough easily. Thus, it is possible to further improve the magnetic attraction.

In addition, in the twelfth embodiment, the yoke member 60 includes the locking portion 16 for locking the core member 50. The locking portion 16 is disposed on the axially outer side (upper side in FIG. 14) of at least a part (the outer front end of the inner part 14a in the radial direction) of the core member 50. For example, under the environment where pressure is low (such as atmospheric) on the outer side (a space where the magnetic core 1 is disposed) in the axial direction with respect to the counterpart material 200 and pressure is high on the opposite side thereto (a space where the counterpart material 200 is disposed), When the locking portion 16 is not provided, but the yoke member 60 and the core member 50 are fixed to each other only by welding, there may arise a problem that a force with which the core member 50 tries to move to the outside (upper side in FIG. 14) in the axial direction acts on the weld portion 90 so that the weld portion 90 is broken to allow the core member 50 to escape to the outside in the axial direction. However, according to the aforementioned configuration, such a force can be received by the locking portion 16. Thus, it is possible to effectively prevent the problem that the core member 50 can escape to the outside in the axial direction.

In addition, at least a part (the outer front end of the inner part 14a in the radial direction) of the core member 50 includes the slope 14x inclined with respect to the axial direction, and the locking portion 16 includes the slope 16x inclined with respect to the axial direction so as to contact with the slope 14x. In this case, due to the contact between the slopes 14x and 16x, locking can be attained to prevent the locking portion 16 from protruding from the core member 50 in the axial direction. Thus, it is possible to avoid the increase in the size of the magnetic core 1 in the axial direction.

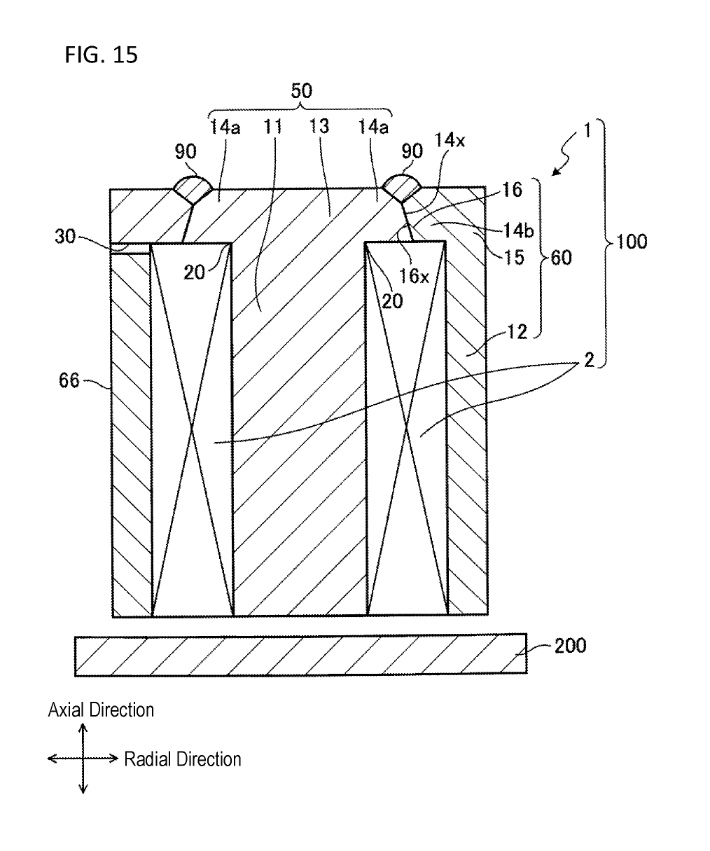

Next, a thirteenth embodiment of the present invention is described with reference to FIG. 15.

A magnetic core 1 according to the thirteenth embodiment has the same configuration as the magnetic core 1 according to the twelfth embodiment, except that the through-hole 30 is provided along the axial direction in the yoke portion 12. The weld portion 90 is not provided in a surface 66 (a surface where the through-hole 30 is opened) of the yoke portion 12 in the yoke member 60.

According to the thirteenth embodiment, similar effects to those of the twelfth embodiment can be obtained by the similar configuration to that of the twelfth embodiment, and the following effect can be obtained in addition thereto.

In the thirteenth embodiment, the through-hole 30 through which the wire of the coil 2 can pass is provided not in the yoke member 50 but in the yoke member 60. In this case, the wire can be inserted with no influence of the positioning accuracy of the core member 50.

### EXAMPLES

Next, the present invention is described specifically along the example(s).

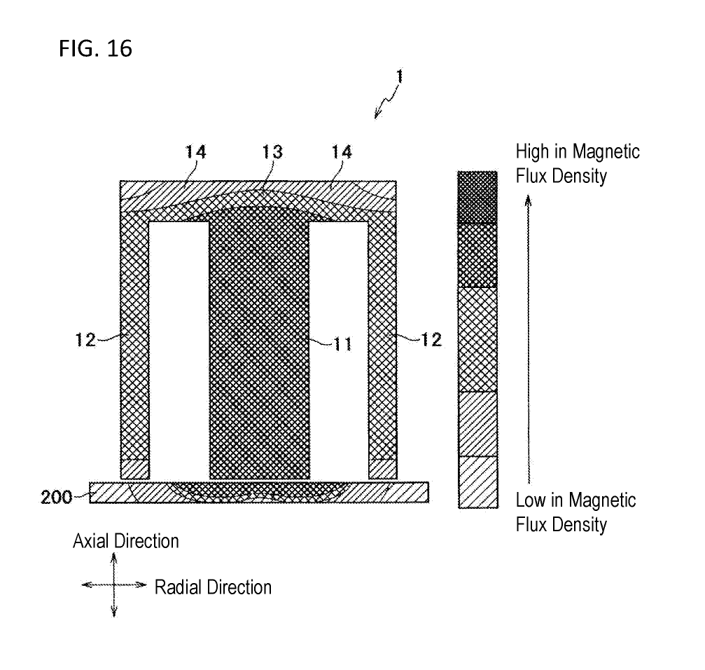

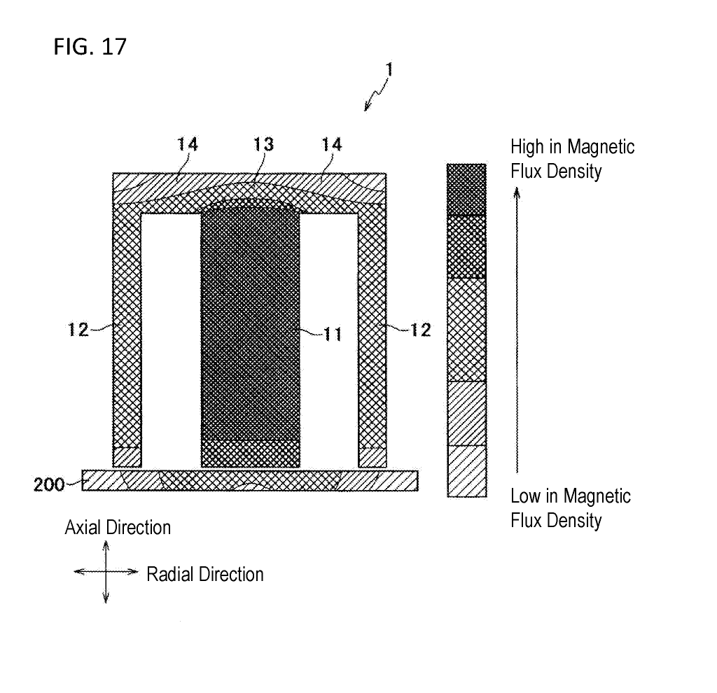

FIG. 16 and FIG. 17 show the analytic results of a magnetic flux density distribution in which one and the same current (a current in a low frequency range (from DC to several hundreds of Hz) was applied to a coil in an electromagnet using a magnetic core according to each of Comparative Example and Example of the present invention.

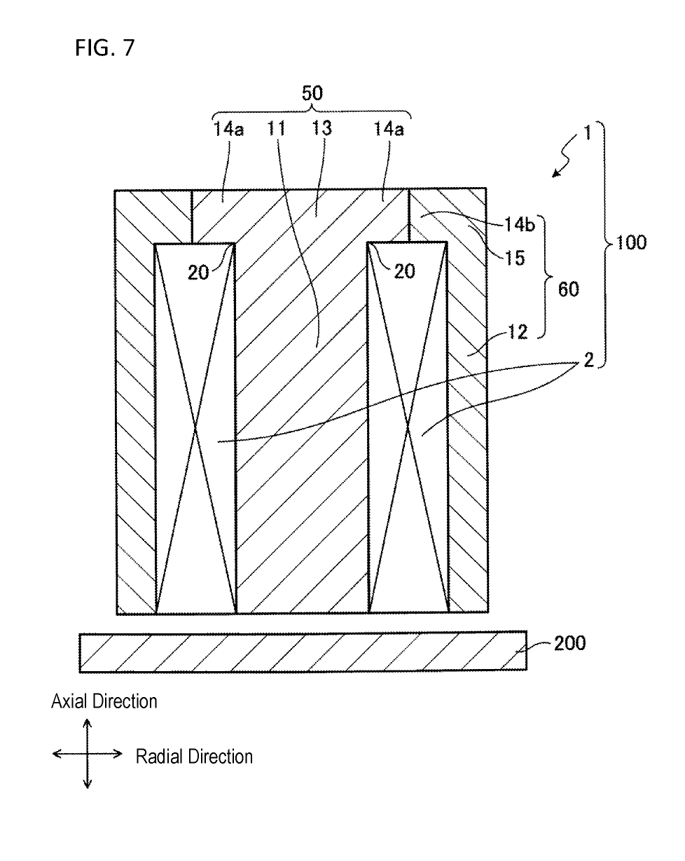

In Comparative Example as in FIG. 16, all the portions (the core portion 11, the yoke portion 12, the opposed portion 13, the non-opposed portion 14, and the like) of the magnetic core 1 having the similar shape to that of each of the fifth to seventh embodiments (see FIG. 6 to FIG. 8) included the general magnetic material.

In Example as in FIG. 17, all the portions (the core portion 11, the yoke portion 12, the opposed portion 13, the non-opposed portion 14, and the like) of the magnetic core 1 having the similar shape to that of each of the fifth to seventh embodiments (see FIG. 6 to FIG. 8) included the high magnetic flux density material.

In Comparative Example as in FIG. 16, it is found that there is a region where magnetic flux density cannot increase to a fixed magnetic flux density in the core portion 11. That is, when the core portion 11 includes the general magnetic material, the core portion 11 locally reaches a high magnetic flux density in the low frequency range and tends to be magnetically saturated. Thus, it is impossible to obtain high magnetic flux density (that is, high magnetic attraction).

In Example as in FIG. 17, it is found that higher magnetic flux density can he obtained in the core portion 11 as compared with the case of Comparative Example as in FIG. 16. That is, when the whole of the core portion 11 includes the high magnetic flux density material, high magnetic flux density can be obtained in the low frequency range to thereby improve the magnetic attraction.

In Comparative Example as in FIG. 16 and Example as in FIG. 17, the sectional areas of the magnetic core 1 inside the coil 2 and outside the coil 2 (that is, the sectional area of the core portion 11 and the sectional area of the yoke portion 12 in a plane perpendicular to the axial direction) are made equal to each other. When the sectional areas of the magnetic core 1 inside the coil 2 and outside the coil 2 are equal, it is expected that the magnetic flux density should be uniform. However, as a result of analysis, it was found that the magnetic flux density increase locally in the core portion 11.

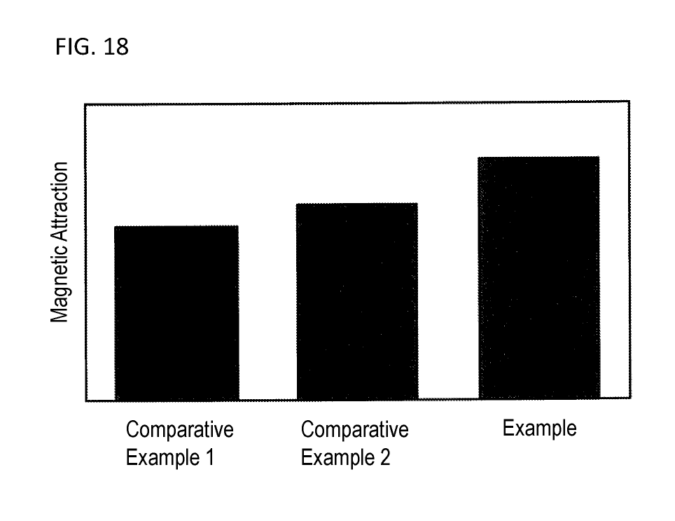

FIG. 18 shows magnetic attraction in the low frequency range in each of a magnetic core in Example of the present invention and magnetic cores in Comparative Examples 1 and 2.

In Comparative Example 1 as in FIG. 18, all the portions (the core portion 11, the yoke portion 12, the opposed portion 13, the non-opposed portion 14, and the like) of the magnetic core 1 having the similar shape to that of each of the fifth to seventh embodiments (see FIG. 6 to FIG. 8) included the general magnetic material, in the same manner as in Comparative Example as in FIG, 16.

In Comparative Example 2 as in FIG. 18, vicinities of end portions of the core portion 11 and the yoke portion 12 facing the counterpart material 200 (that is, the vicinity of the other end of the core portion 11 in the axial direction and the vicinity of the other end of the yoke portion 12 in the axial direction) included the high magnetic flux density material, and the other portions included the general magnetic material.

In Example of FIG. 18, all the portions (the core portion 11, the yoke portion 12, the opposed portion 13, the non-opposed portion 14, etc.) of the magnetic core 1 having the similar shape to that of each of the fifth to seventh embodiments (see FIG. 6 to FIG. 8) included the high magnetic flux density material, in the same manner as in Example of FIG. 17.

From FIG. 18, it is found that, in the low frequency range, higher magnetic attraction can be obtained in Comparative Example 2 as compared with the case of Comparative Example 1. and higher magnetic attraction can be obtained in Example as compared with the case of Comparative Example 2. in Comparative Example 2, the magnetic attraction in the low frequency range is slightly improved as compared with that in Comparative Example 1. However, it is found that the effect of improving the magnetic attraction in the low frequency range is limited since the high magnetic flux density material is limited to a part of the core portion 11.

Although the preferred embodiments of the present invention have been described above, the present invention is not limited to the aforementioned embodiments, various changes can be performed on the design thereof as long as they fall within the scope of the claims.

The core portion is not limited to the columnar shape and may have a prismatic shape or the like. In addition, the core portion does not have to be a solid body (that is, may have a hollow).

The York portion is not limited to the cylindrical shape and may have a rectangular tubular shape or the like.

The respective portions (the core portion, the yoke portion, the opposed portion, the non-opposed portion, and the like) of the magnetic core may be made of the same member, or may be made of different members.

The materials of the other parts (the yoke portion, the opposed portion, the non-opposed portion, or the like) than the core portion are not limited particularly, as long as the whole of the core portion includes the high magnetic flux density material. The whole of the magnetic core may include the high magnetic flux density material as in the aforementioned Example.

The fitting portion is not limited to a concave portion but may be a convex portion.

The fitting portion is not limited to be fitted to the non-opposed portion, but may be fitted to any part of the core member.

The locking portion is not limited to lock the non-opposed portion, but may lock any part of the core member.

The magnetic core according to the present invention is not limited to be used in a magnetic force generator in an apparatus for measuring dynamic characteristics of a centrifugal type rotary machine, but may be used in any electromagnet.

While the present invention has been described in detail and with reference to specific embodiments thereof, it will be apparent to one skilled in the art that various changes and modifications can be made therein without departing from the spirit and scope thereof.

This application is based on Japanese Patent Application No. 2016-101504 filed on May 20, 2016 and Japanese Patent Application No. 2016-200368 filed on Oct. 11, 2016, the entire subject matters of which are incorporated herein by reference.

### INDUSTRIAL APPLICABILITY

According to the present invention, it is possible to improve magnetic attraction without increasing the size of a magnetic core in an electromagnet.

### Description of Reference Numerals and Signs

1 Magnetic core

2 Coil

11 Core portion

12 Yoke portion

13 Opposed portion

14 Non-opposed portion

14a Inner part

14b Outer part

14x Slope (first slope)

16 Locking portion

16x Slope (second slope, fitting portion

20 Corner portion

30 Through-hole

50 Core member

51 Surface

60 Yoke member

61 Concave portion (fitting portion)

62 Concave portion (fitting portion)

63 Concave portion (fitting portion)

65 Surface

66 Surface

90 Weld portion

100 Electromagnet

1. A magnetic core comprising:
a columnar core portion that is disposed inside a cylindrical coil and overlaps with an arrangement region of the coil in an axial direction; and
a cylindrical yoke portion that is disposed outside the coil and overlaps with the arrangement region of the coil in the axial direction,
wherein at least the whole of the core portion comprises a high magnetic flux density material that has a magnetic flux density higher than that of a general magnetic material.

2. The magnetic core according to claim 1, wherein the yoke portion comprises the general magnetic material.

3. The magnetic core according to claim 1, wherein the high magnetic flux density material is an Fe—Co alloy.

4. The magnetic core according to claim 1, further comprising:
an opposed portion that is connected to the core portion, does not overlap with the arrangement region of the coil in the axial direction, and is opposed to the core portion in the axial direction; and
a non-opposed portion that is connected to the opposed portion, does not overlap with the arrangement region of the coil in the axial direction, and is not opposed to the core portion in the axial direction,
wherein a corner portion formed by the core portion and the non-opposed portion has a round shape.

5. The magnetic core according to claim 1, further comprising:
an opposed portion that is connected to the core portion, does not overlap with the arrangement region of the coil in the axial direction, and is opposed to the core portion in the axial direction; and
a non-opposed portion that is connected to the opposed portion, does not overlap with the arrangement region of the coil in the axial direction, and is not opposed to the core portion in the axial direction,
wherein a corner portion formed by the core portion and the non-opposed portion has a chamfered shape.

6. The magnetic core according to claim 1, further comprising an opposed portion that is connected to the core portion, does not overlap with the arrangement region of the coil in the axial direction, and is opposed to the core portion in the axial direction,
wherein the opposed portion comprises the high magnetic flux density material.

7. The magnetic core according to claim 6, comprising a columnar core member that includes the core portion and the opposed portion.

8. The magnetic core according to claim 6, further comprising a non-opposed portion that is connected to the opposed portion, does not overlap with the arrangement region of the coil in the axial direction, and is not opposed to the core portion in the axial direction,
wherein at least an inner part connected to the opposed portion in the non-opposed portion comprises the high magnetic flux density material.

9. The magnetic core according to claim 8, wherein the non-opposed portion includes an inner part connected to the opposed portion and an outer part disposed on the outer side of the coil relative to the inner part,
wherein the inner part comprises the high magnetic flux density material and the outer part comprises the general magnetic material.

10. The magnetic core according to claim 1, wherein a weld portion is not provided in a surface where a through-hole through which a wire of the coil can pass is opened.

11. The magnetic core according to claim 1, wherein a through-hole through which a wire of the coil can pass is provided in a yoke member forming the yoke portion and is not provided in a core member forming the core portion.

12. The magnetic core according to claim 1, wherein a yoke member forming the yoke portion includes a fitting portion that is fitted to a core member forming the core portion.

13. The magnetic core according to claim 1, wherein a yoke member forming the yoke portion includes a locking portion that is disposed in at least a part of the core member and outside the core member in the axial direction so that the core member forming the core portion is locked to the locking portion.

14. The magnetic core according to claim 13, wherein:
at least a part of the core member includes a first slope that is inclined with respect to the axial direction; and
the locking portion includes a second slope that is inclined with respect to the axial direction so as to contact with the first slope.

15. The magnetic core according to claim 1, wherein the core portion is a solid body.
